(19) United States
(12) Patent Application Publication
(10) Pub. No.: US 2026/0137238 A1
(43) Pub. Date: May 21, 2026

(54) MULTIFUNCTIONAL COFFEE BEAN GRINDER

(71) Applicant: CHING-CHUAN YU, Taichung City (TW)

(72) Inventor: CHING-CHUAN YU, Taichung City (TW)

(21) Appl. No.: 19/388,193

(22) Filed: Nov. 13, 2025

(30) Foreign Application Priority Data
Nov. 18, 2024 (TW) 113212576

(51) Int. Cl. A47J 42/16; A47J 42/06; A47J 42/42; A47J 42/46

(52) U.S. Cl. CPC A47J 42/16; A47J 42/06; A47J 42/42; A47J 42/46

(57) ABSTRACT

A multifunctional coffee bean grinder contains a motor. The motor has a driving shaft with a first coupling portion and a second coupling portion which simultaneously output power and are respectively connected to a first grinding unit and a second grinding unit. The first grinding unit includes a first fixed tooth member and a first movable tooth member, the first movable tooth member is connected with the first coupling portion so as to be driven by the motor to rotate for grinding coffee beans into flake-shaped powder particles. The second grinding unit includes a second fixed tooth member and a second movable tooth member, the second fixed tooth member is fixed to the body, and the second movable tooth member has a center connected with the second coupling portion so as to be driven by the motor to rotate for grinding coffee beans into three-dimensional granular powder.

### TECHNICAL FIELD

The present invention relates to a grinder, and more particularly to a multifunctional coffee bean grinder.

### BACKGROUND

Conventionally, coffee bean grinders generally employ two types of burr structures, namely flat burrs and conical burrs. The flat burr type also referred to as flat plate burrs or ghost burrs, grinds coffee beans into flake-shaped powder. The conical burr type utilizes a gap between an annular member and a conical burr to grind coffee beans into three-dimensional granular powder. Different coffee brewing methods require coffee powders of corresponding particle sizes. If the grinder produces coffee powders with uneven particle sizes, the flavor of the brewed coffee will be adversely affected.

With reference to FIG. 4, a conventional coffee bean grinder employing flat burrs generally comprises a base 10, a feeding disc 20, a front cover 30, and an adjusting cover 40. The grinder primarily operates by using a motor to drive the feeding disc 20 and a feeding screw 21 for spiral advancement, thereby guiding coffee beans from a feeding chamber 161 into a grinding chamber 17 between a first burr plate 19 and a second burr plate 26. The coffee beans are ground through the high-speed rotation of the second burr plate 26 within the feeding disc 20. By rotating the adjusting cover 40, the distance between the first burr plate 19 and the second burr plate 26 can be adjusted, enabling the production of coffee powders of different particle sizes. Although the conventional grinder provides an adjustable grinding function, when the grinder is adjusted to produce both the smallest and largest particle sizes, due to the shallow-to-deep design of the burr teeth, approximately fifteen to twenty percent of the ground coffee particles fail to meet the desired size specification.

Another conventional coffee bean grinder, as shown in FIG. 5, is disclosed in Taiwan, and the conventional coffee bean grinder contains: a crushing unit 84, a separating unit 85, a grinding unit 86, and a driving unit 87 mounted on a main body. The crushing unit 84 includes a conical burr plate 88 and a conical burr 89 for breaking coffee beans into multiple bean fragments and multiple endosperm membranes. The grinding unit 86 is used to grind the bean fragments into fine powder and also includes a conical burr plate 90 and a conical burr 91. The driving unit 87 connects an upper section of a spindle 92 to the conical burr 89 of the crushing unit 84, and a lower section of the spindle 92 to the conical burr 91 of the grinding unit 86. An output shaft 94 of a motor 93 is coupled to a gear 95 mounted at the end of the spindle 92, so that when the motor 93 drives the spindle 92 to rotate, both the conical burr 89 and the conical burr 91 rotate simultaneously. The separating unit 85 is installed between the crushing unit 84 and the grinding unit 86, and a fan 96 generates suction to draw the endosperm membranes into a collecting chamber 97. Although this design enables the coffee beans to be separated and finely ground after removing the endosperm membranes, the grinder is still capable of producing only one type of coffee powder and its mechanical structure is relatively complex.

Accordingly, a conventional grinder typically produces only flake-shaped coffee powder, and the particle sizes of the ground powder are not uniform. Therefore, there is a need in the industry to provide a grinder capable of stably grinding coffee powders of different particle sizes and simultaneously producing both flake-shaped and three-dimensional granular coffee powders.

The present invention has arisen to mitigate and/or obviate the afore-described disadvantages.

### SUMMARY

The primary objective of the present invention is to provide a multifunctional coffee bean grinder, which is configured with two grinding units to enable simultaneous grinding of coffee powders of different particle sizes, including both flake-shaped and three-dimensional granular coffee powders, thus enhancing the overall functionality and versatility.

To achieve the above-mentioned objective, a multifunctional coffee bean grinder provided by the present invention contains a motor disposed at an predetermined position in a middle portion of a vertically oriented grinder body, the motor has a driving shaft with a first coupling portion and a second coupling portion respectively formed at two ends of the motor, the first and second coupling portions simultaneously output power to be respectively connected to a first grinding unit and a second grinding unit.

The first grinding unit includes a first fixed tooth member and a first movable tooth member, the first fixed tooth member is a disc-shaped structure connected to an end of the body through a first cover, and the first movable tooth member is also a disc-shaped structure disposed opposite to the first fixed tooth member in a meshing relationship, the first movable tooth member is connected with the first coupling portion so as to be driven by the motor to rotate for grinding coffee beans into flake-shaped powder particles.

The second grinding unit includes a second fixed tooth member and a second movable tooth member, the second fixed tooth member is an annular structure fixed to the other end of the body, and the second movable tooth member is a conical structure having a center connected and fixed with the second coupling portion so as to be driven by the motor to rotate for grinding coffee beans into three-dimensional granular powder.

### BRIEF DESCRIPTION OF THE DRAWINGS

FIG. 1 is a cross sectional view showing the assembly of a multifunctional coffee bean grinder according to a preferred embodiment of the present invention.

FIG. 2 is a cross sectional view showing the operation of the multifunctional coffee bean grinder according to the preferred embodiment of the present invention.

FIG. 3 is another cross sectional view showing the operation of the multifunctional coffee bean grinder according to the preferred embodiment of the present invention.

FIG. 4 is a side plan view of a conventional coffee bean grinder.

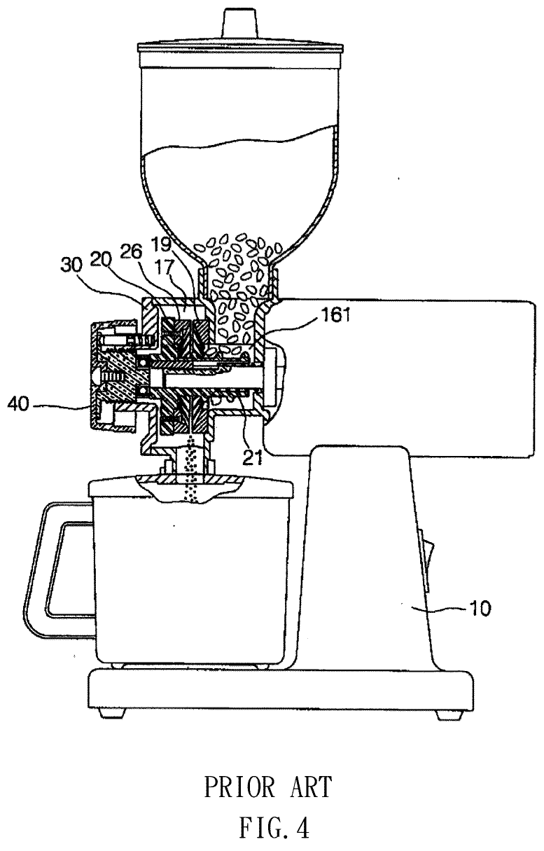

FIG. 5 is a perspective view of another conventional coffee bean grinder.

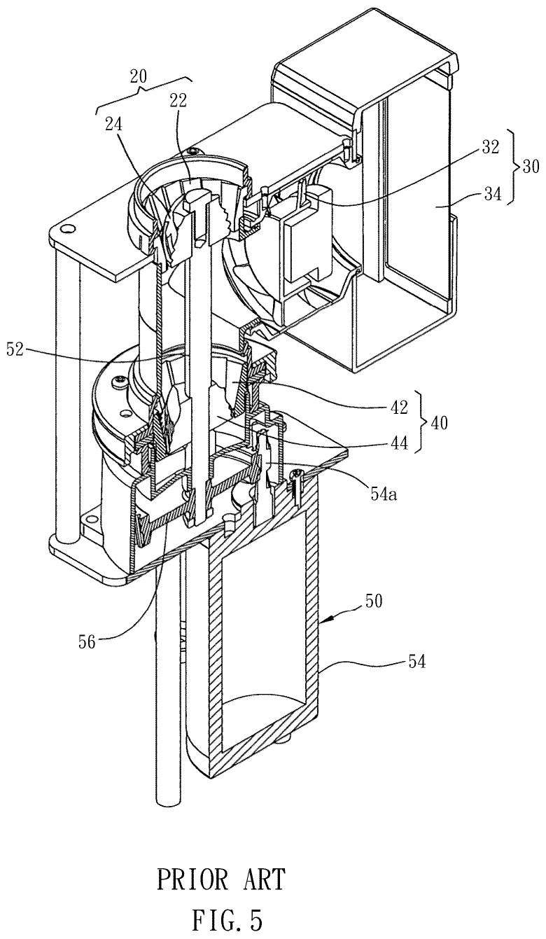

### DETAILED DESCRIPTION

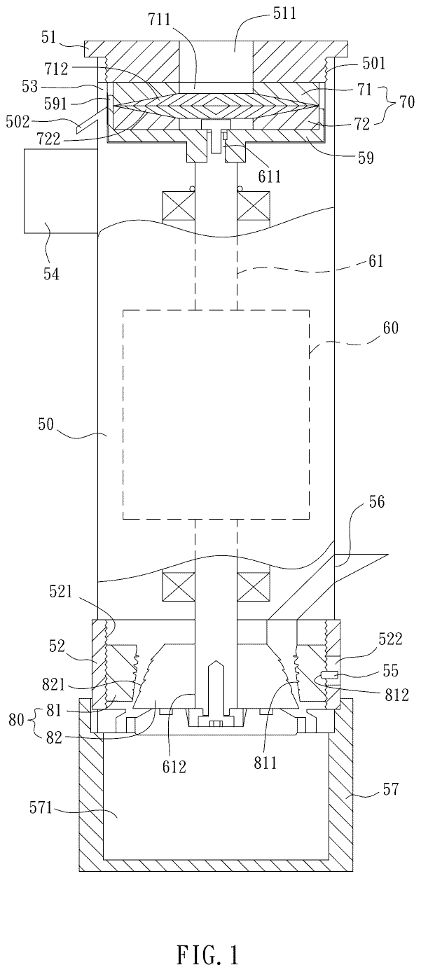

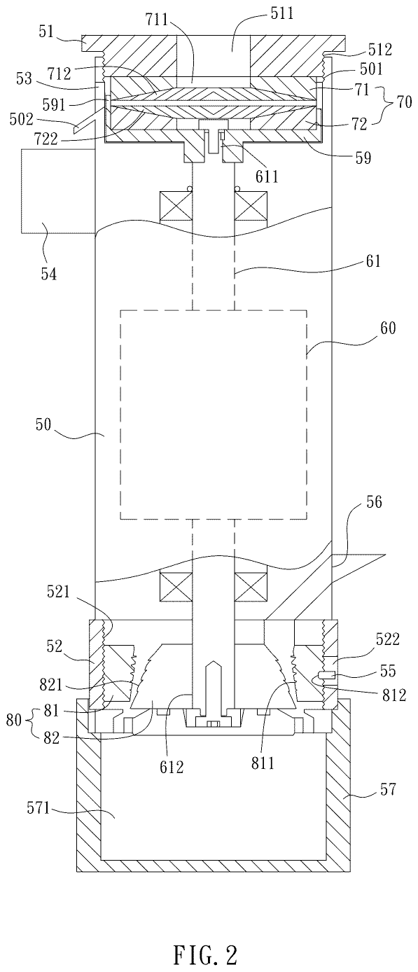

With reference to FIGS. 1-3, a multifunctional coffee bean grinder according to a preferred embodiment of the present invention comprises: a body 50, a motor 60, a first grinding unit 70, and a second grinding unit 80.

The body 50 is a vertically oriented structure. A first internal thread 501 is formed at an outer wall of an end of the body 50 for screwing a first cover 51 thereon, through which the first grinding unit 70 is mounted and fixed. The other end of the body 50 is provided with a housing sleeve 52 or a second cover 58 for connecting the second grinding unit 80.

The motor 60 is a conventional motor or a variable-speed motor and is disposed within a middle portion of the body 50, and the motor 60 is powered by batteries or an indoor power source. The motor 60 includes a driving shaft 61 having both ends configured to simultaneously output power. The two ends of the driving shaft 61 respectively include a first coupling portion 611 and a second coupling portion 612, which are configured to connect with the first grinding unit 70 and the second grinding unit 80, respectively.

The first grinding unit 70 includes a first fixed tooth member 71 and a first movable tooth member 72. The first fixed tooth member 71 is a disc-shaped structure fixed to an inner surface of the first cover 51. The first movable tooth member 72 is also a disc-shaped structure fixed on a positioning base 59. The positioning base 59 is connected and fixed to the first coupling portion 611 so that the first movable tooth member 72 and the first fixed tooth member 71 are oppositely arranged in a meshing relationship. A through hole 711 is formed at a center of the first fixed tooth member 71, and multiple first grinding teeth 712 are formed on an outer surface of the through hole 711. A first feeding inlet 511 is formed at a center of the first cover 51 and aligned with the through hole 711. Furthermore, a first external thread 512 is formed around an outer circumferential surface of the first cover 51, and the first external thread 512 is screwed with the first internal thread 501 of the body 50, such that the first cover 51 rotates and axially moves along the body 50, thus adjusting a distance between the first grinding teeth 712 and a second grinding teeth 722.

Furthermore, the body 50 is provided with a discharging port 53 at a suitable position corresponding to an outer surface of the first movable tooth member 72. An extending guide plate 502 is formed at an outer end of the discharging port 53, and a container 54 is disposed below the guide plate 502 for collecting the ground coffee powder. An outer surface of a positioning base 59 is provided with a plurality of protruded blades 591 extending outward at an inclined angle. The blades 591 rotate together with the first movable tooth member 72 and are configured to push ground coffee particles toward the discharging port 53 so that the ground coffee falls outward through the discharging port 53.

The second grinding unit 80 includes a second fixed tooth member 81 and a second movable tooth member 82. The second fixed tooth member 81 is an annular structure, and a plurality of third grinding teeth 813 are formed on an inner surface of the second fixed tooth member 81. The second movable tooth member 82 is a conical structure, and a plurality of fourth grinding teeth 821 are formed on an outer conical surface thereof. A center of the second movable tooth member 82 is connected and fixed to the second coupling portion 612.

Furthermore, the second fixed tooth member 81 has a second external thread 811 formed on an outer surface thereof, and an inner surface of a housing sleeve 52 is provided with a second internal thread 521. The second fixed tooth member 81 is connected to the housing sleeve 52 by screwing the second external thread 811 into the second internal thread 521. At an appropriate position where the second external thread 811 is formed, an internal threaded hole 812 is further provided on the second fixed tooth member 81. The housing sleeve 52 has an elongated slot 522 corresponding to the internal threaded hole 812. A limit rod 55 has an end screwed into the internal threaded hole 812 and the other end of the limit rod 55 protruding into the elongated slot 522. When the housing sleeve 52 is rotated, the second fixed tooth member 81 is restricted from a rotation and only allowed to move up and down along the elongated slot 522, thus adjusting a distance between the third grinding teeth 813 and the fourth grinding teeth 821.

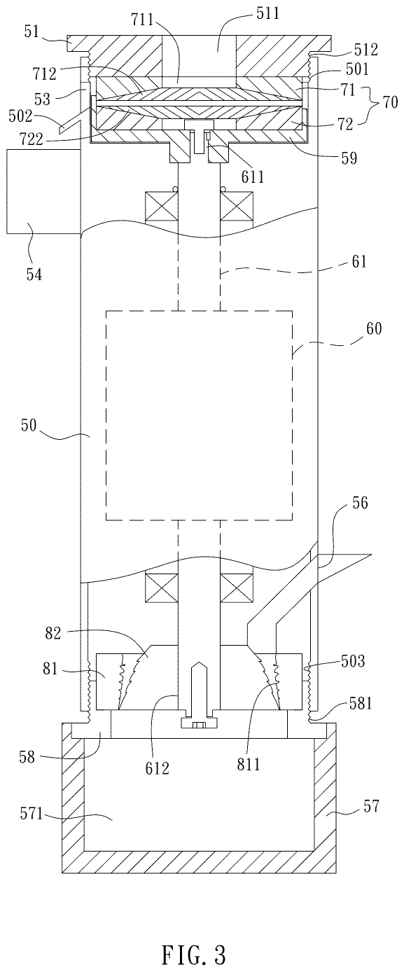

As shown in FIG. 3, the second fixed tooth member 81 is connected to the body 50 by using a second cover 58. A center of the second cover 58 is formed as a through hollow structure, in which the second fixed tooth member 81 is fixed to an inner surface of the second cover 58. An outer surface of the second cover 58 is provided with a third external thread 581, and an inner wall at the other end of the body 50 is provided with a third internal thread 503. By engaging the third external thread 581 with the third internal thread 503, the second cover 58 rotates and axially moves along the body 50 to adjust the distance between the third grinding teeth 813 and the fourth grinding teeth 821.

A first internal thread 501 is formed at an outer wall of an end of the body 50

The body 50 includes a second feeding inlet 56 at a predetermined position on an outer wall of the other end of the body 50 above the second fixed tooth member 81 and the second movable tooth member 82, thus allowing coffee beans to be placed into the second feeding inlet 56 and fall between the second fixed tooth member 81 and the second movable tooth member 82. A base 57 is disposed below the second movable tooth member 82 of the body 50. The base 57 includes a hollow accommodating portion 571 formed therein, which is used for collecting coffee powder ground by the second fixed tooth member 81 and the second movable tooth member 82.

In operation, the motor 60 simultaneously drives the first grinding unit 70 and the second grinding unit 80 to rotate. Under the condition that the motor 60 provides sufficient torque, a single grinder is capable of grinding coffee beans into powders of different particle sizes, and of simultaneously producing both flake-shaped and granular coffee powder. Also, the user is capable of selectively operating only one of the grinding units according to a desired requirement, thus enhancing the functional versatility of the grinder.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A multifunctional coffee bean grinder comprising a motor disposed at an predetermined position in a middle portion of a vertically oriented grinder body, the motor having a driving shaft with a first coupling portion and a second coupling portion respectively formed at two ends of the motor, the first and second coupling portions simultaneously outputting power to be respectively connected to a first grinding unit and a second grinding unit;
wherein the first grinding unit includes a first fixed tooth member and a first movable tooth member, the first fixed tooth member is a disc-shaped structure connected to an end of the body through a first cover, and the first movable tooth member is also a disc-shaped structure disposed opposite to the first fixed tooth member in a meshing relationship, the first movable tooth member is connected with the first coupling portion so as to be driven by the motor to rotate for grinding coffee beans into flake-shaped powder particles;
wherein the second grinding unit includes a second fixed tooth member and a second movable tooth member, the second fixed tooth member is an annular structure fixed to the other end of the body, and the second movable tooth member is a conical structure having a center connected and fixed with the second coupling portion so as to be driven by the motor to rotate for grinding coffee beans into three-dimensional granular powder.

2. The multifunctional coffee bean grinder as claimed in claim 1, wherein the end of the body corresponding to the first grinding unit is screwed with a first cover, the first cover has a first feeding inlet formed thereon, the first fixed tooth member is fixed to an inner surface of the first cover, a through hole is formed at a center of the first fixed tooth member, and multiple first grinding teeth are formed on an outer surface around the through hole.

3. The multifunctional coffee bean grinder as claimed in claim 1, wherein the body is provided with a discharging port at a predetermined position corresponding to an outer surface of the first movable tooth member, a guide plate is outwardly extended from an outer end of the discharging port, and a plurality of blades are protrudedly formed along an outer surface of the first movable tooth member, the plurality of blades rotate together with the first movable tooth member to push the ground coffee particles toward the discharging port so that the ground coffee falls outward through the discharging port.

4. The multifunctional coffee bean grinder as claimed in claim 1, wherein plurality of third grinding teeth are formed on an inner surface of the second fixed tooth member, and a plurality of fourth grinding teeth are formed on an outer conical surface of the second movable tooth member; the second fixed tooth member has a second external thread formed on an outer l surface thereof, and the body includes a rotatable housing sleeve corresponding to the second fixed tooth member, the housing sleeve has a second internal thread formed on an inner surface thereof, such that the second fixed tooth member is screwed to the housing sleeve by screwing the second external thread into the second internal thread; an internal threaded hole is further formed on the second fixed tooth member, and the housing sleeve has an elongated slot corresponding to the internal threaded hole; a limit rod has an end screwed into the internal threaded hole and the other end protruding into the elongated slot, so that when the housing sleeve is rotated, the second fixed tooth member is driven to move upward and downward, thus adjusting a distance between the third grinding teeth and the fourth grinding teeth.

5. The multifunctional coffee bean grinder as claimed in claim 1, wherein base is disposed below the second movable tooth member of the body, the base has a hollow accommodating portion formed therein for collecting coffee powder ground by the second fixed tooth member and the second movable tooth member.

6. The multifunctional coffee bean grinder as claimed in claim 4, wherein base is disposed below the second movable tooth member of the body, the base has a hollow accommodating portion formed therein for collecting coffee powder ground by the second fixed tooth member and the second movable tooth member.

7. The multifunctional coffee bean grinder as claimed in claim 1, wherein the body includes a second feeding inlet at an predetermined position on an outer wall thereof above the second fixed tooth member and the second movable tooth member, thus allowing coffee beans to be placed into the second feeding inlet and fall between the second fixed tooth member and the second movable tooth member.

8. The multifunctional coffee bean grinder as claimed in claim 1, wherein the other end of the body corresponding to the second grinding unit is screwed with a second cover, a center of the second cover is formed as a through hollow structure in which the second fixed tooth member is fixed to an inner surface of the second cover; the body further includes a second feeding inlet at an predetermined position on an outer wall of the body above the second fixed tooth member and the second movable tooth member, thus allowing coffee beans to be placed into the second feeding inlet and fall between the second fixed tooth member and the second movable tooth member; wherein a base is disposed below the second movable tooth member of the body, the base has a hollow accommodating portion formed therein for collecting the coffee powder ground by the second fixed tooth member and the second movable tooth member.
